(19) United States
(12) Patent Application Publication
(10) Pub. No.: US 2026/0155132 A1
(43) Pub. Date: Jun. 4, 2026

(54) NATURALNESS OF SPEAKER-ADAPTED SPEECH SYNTHESIS

(71) Applicant: Fraunhofer-Gesellschaft zur Foerderung der angewandten Forschung e.V., München (DE)

(72) Inventors: Frank ZALKOW, Burgthann (DE); Paolo SANI, Nürnberg (DE); Christian DITTMAR, Wachenroth (DE)

(73) Assignee: Fraunhofer-Gesellschaft zur Foerderung der angewandten Forschung e.V., München (DE)

(21) Appl. No.: 18/964,128

(22) Filed: Nov. 29, 2024

(51) Int. Cl. G10L 13/027; G10L 13/033; G10L 13/047; G10L 13/10; G10L 25/18

(52) U.S. Cl. CPC G10L 13/027; G10L 13/033; G10L 13/047; G10L 13/10; G10L 25/18

(57) ABSTRACT

Techniques of improving the naturalness of synthetic speech are disclosed. Speaker-adaption of a speech synthesis pipeline by training of an acoustic model and a post-processing model for modifying speech features output by the acoustic model are disclosed. For this training, additional reference training samples are obtained based on simulated low-resource input-output datasets for reference speakers.

### FIELD OF THE INVENTION

Various examples of the disclosure generally pertain to speech synthesis. Various examples of the disclosure specifically pertain to training at least parts of a speech synthesis pipeline.

### BACKGROUND OF THE INVENTION

Speech synthesis relates to techniques in which speech is artificially created. Speech synthesis includes text-to-speech (TTS) synthesis, voice conversion, as well as TTS-based speech coding.

Modern speech synthesis pipelines usually have an acoustic model implemented by a deep neural network. The acoustic model maps symbolic text inputs to speech features, such as mel-scaled spectrograms. The speech synthesis pipeline further includes a vocoder that maps the speech features output by the acoustic model to an audio speech output, e.g., to speech waveforms. The speech waveforms can be played back.

The acoustic model is trained using an input-output (I/O) dataset including text inputs and associated speech features; these pairs of text inputs and associated speech features form training samples. The speech features establish a ground truth for the training of the acoustic model. The speech features are typically extracted from real speech recordings. The text inputs are transcripts of the speech recordings.

When having a large amount of training samples (e.g., 5 hours or more of speech recording and associated text inputs) for a particular speaker, the speech synthesis pipeline can be trained to produce highly realistic speech features corresponding to the voice of the high-resource speaker using techniques available in the prior art.

However, a speech synthesis pipeline often performs poorly when only a relatively limited amount of training samples for a particular speaker is available. For instance, it has been observed that a speech synthesis pipeline trained with less than 5 hours of speech recordings and associated text inputs tends to perform poorly. The generated speech sounds artificial. The speech lacks naturalness.

It has been observed that such poor performance can be caused by the so-called “over-smoothing” effect. See Yi Ren, Xu Tan, Tao Qin, Zhou Zhao, and Tie-Yan Liu, “Revisiting over-smoothness in text to speech,” in Proceedings of the Annual Meeting of the Association for Computational Linguistics, Dublin, Ireland, 2022, pp. 8197-8213. This means that the generated spectrograms lack fine-grained noise-like texture if compared to real spectrograms. But there are also other types of artifacts observed when training samples are limited, such as a poor representation of the speaker's timbre.

### SUMMARY OF THE INVENTION

Accordingly, a need exists for advanced speech synthesis. In particular, a need exists for synthesis with improved naturalness of the audio speech output. More specifically, a need exists for speech synthesis pipelines that can be trained for a target speaker based on a relatively small-sized I/O dataset including training samples for that target speaker.

Techniques are disclosed that enable to determine additional training samples for a generative post-processing model of a speech synthesis pipeline by inferring one or more reference instances of an acoustic model of the speech synthesis pipeline.

A computer-implemented method of obtaining a speech synthesis pipeline is disclosed. The speech synthesis pipeline is adapted to a target speaker. The speech synthesis pipeline includes an acoustic model for determining speech features based on input. The speech synthesis pipeline also includes a generative post-processing model for modifying the speech features. The speech synthesis pipeline further includes a vocoder for determining an audio speech output based on the modified speech features. The method includes obtaining a first input-output dataset for the target speaker. The first input-output dataset includes respective inputs and associated speech features. The method also includes obtaining one or more second input-output datasets for one or more reference speakers. Each of the one or more second input-output datasets includes respective inputs and associated speech features. A size of each of the one or more second input-output dataset is larger than a size of the first input-output dataset. The method further includes, for each of the one or more second input-output datasets, obtaining a respective third input-output dataset that includes a part of the inputs and associated speech features of the associated second input-output dataset. The method further includes training the acoustic model using the first input-output dataset and at least one of the one or more second input-output datasets. The method also includes, for each of the one or more third input-output datasets: training a respective reference instance of the acoustic model using the respective third input-output dataset. The method further includes using the trained acoustic model to infer synthesized speech features based on the inputs included in the first input-output dataset. The method also includes, for each trained reference instance of the acoustic model, using the respective trained reference instance of the acoustic model to infer respective synthesized reference speech features based on the inputs included in the associated second input-output dataset. The method also includes training the generative post-processing model based on the synthesized speech features, the synthesized reference speech features, the speech features included in the first input-output dataset, and the speech features included in the one or more second input-output datasets.

A processing device includes a memory and at least one processor. The at least one processor is configured to load program code from the memory and to execute the program code. The at least one processor, upon loading and executing the program code, is configured to obtain a first input-output dataset for a target speaker, the first input-output dataset including respective inputs and associated speech features. The at least one processor, upon loading and executing the program code, is further configured to obtain one or more second input-output datasets for one or more reference speakers, each of the multiple second input-output datasets including respective inputs and associated speech features, a size of each of the one or more second input-output datasets being larger than a size of the first input-output dataset. The at least one processor, upon loading and executing the program code, is configured to obtain a respective third input-output dataset including a part of the inputs and associated speech features of the associated second input-output dataset for each of the one or more second input-output datasets. The at least one processor, upon loading and executing the program code, is further configured to train an acoustic model of a speech synthesis pipeline using the first input-output dataset and at least one of the one or more second input-output datasets. The at least one processor, upon loading and executing the program code, is further configured to, for each of the one or more third input-output datasets, to train a respective reference instance of the acoustic model using the respective third input-output dataset. The at least one processor, upon loading and executing the program code, is further configured to use the trained acoustic model to infer synthesized speech features based on the inputs included in the first input-output dataset. The at least one processor, upon loading and executing the program code, is further configured to, for each trained reference instance of the acoustic model, use the respective trained reference instance of the acoustic model to infer respective synthesized reference speech features based on the inputs included in the associated second input-output dataset. The at least one processor, upon loading and executing the program code, is further configured to train a generative post-processing model of the speech synthesis pipeline based on the synthesized speech features, the synthesized reference speech features, the speech features included in the first input-output dataset, and the speech features included in the one or more second input-output datasets.

It is to be understood that the features mentioned above and those yet to be explained below may be used not only in the respective combinations indicated, but also in other combinations or in isolation without departing from the scope of the disclosure.

### BRIEF DESCRIPTION OF THE DRAWINGS

FIG. 1 schematically illustrates a speech synthesis pipeline including an acoustic model, a post-processing model according to various examples.

FIG. 2 schematically illustrates spectrograms.

FIG. 3 schematically illustrates I/O data sets according to various examples.

FIG. 4 schematically illustrates training of an acoustic model in multiple reference instances of the acoustic model according to various examples.

FIG. 5 is a flowchart of a method according to various examples.

FIG. 6 schematically illustrates a processing device according to various examples.

### DETAILED DESCRIPTION OF THE INVENTION

Some examples of the present disclosure generally pertain to processing devices, circuits, or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), a tensor processing unit (TPU), integrated circuits such as application-specific integrated circuits or field-programmable gate array (FPGA) circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the disclosure will be described in detail with reference to the accompanying drawings. It is to be understood that the following description of embodiments is not to be taken in a limiting sense. The scope of the disclosure is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques related to speech synthesis are disclosed. The disclosed techniques are generally applicable to TTS speech synthesis as well as to other forms of speech synthesis, including speech-to-speech (STS) synthesis (i.e., voice conversion).

Hereinafter, aspects related to training of a speech synthesis pipeline, e.g., a TTS or STS synthesis pipeline, are disclosed. Techniques for a speaker adaptation of a speech synthesis pipeline are disclosed. Techniques for improved naturalness of a speaker-adapted speech synthesis pipeline are disclosed.

The techniques are described primarily in the context of the concrete example of a TTS synthesis pipeline; this is for illustrative purposes. However, the disclosed techniques can be equally applied to other forms of speech synthesis, e.g., STS synthesis pipelines.

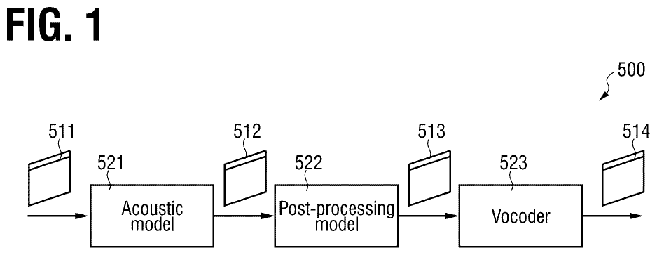

FIG. 1 schematically illustrates a TTS synthesis pipeline 500 according to various examples. The TTS synthesis pipeline 500 includes an acoustic model 521 that determines speech features 512 based on text inputs 511. The TTS synthesis pipeline 500 also includes a generative post-processing model 522 that modifies the speech features 512, i.e., outputs modified speech features 513. These modified speech features 513 are fed to a vocoder 523 that determines an audio speech output 514.

The acoustic model 521 is typically a neural network-based model that—for the TTS synthesis—accepts the text input 511. The text input 511 typically includes a sequence of phoneme symbols or a sequence of text characters.

The acoustic model 521 outputs a corresponding sequence of speech features, such as mel-scale spectrograms or other types of spectral representations. Speech features may also be expressed in a machine-learned features space, i.e., may be so-called audio embeddings. A neural-network based model may be implemented using various types of neural network architectures, such as feedforward networks, convolutional neural networks, recurrent neural networks, or long short-term memory networks.

The post-processing model may be a generator model of a generative adversarial network (GAN). Also, other implementations of the post-processing model are possible; for sake of simplicity, hereinafter, reference is primarily made to an implementation by a generator model of a GAN.

A GAN is a type of deep learning algorithm that includes two models: a generator model and a discriminator model. The generator model takes a random noise vector as input and (additionally based on a conditioning, e.g., in the present case the speech features) generates synthetic data samples, such as in the present case synthetic speech features that aim to resemble real data samples, such as recorded/ground-truth speech features of training samples. The discriminator model, on the other hand, evaluates the generated data samples and predicts whether they are real or fake. Through training, the generator model learns to produce more realistic data samples by minimizing the difference between its generated synthetic data samples and the real data samples.

According to various examples, the post-processing model 522 may be selectively activated. For instance, if the post-processing model 522 is deactivated, the vocoder 523 may receive, as an input, the (non-modified) speech features 512. On the other hand, if the post-processing model 522 is activated, then the vocoder 523 receives, as the input, the modified speech features 513, as illustrated in FIG. 1. Selective deactivation of the post-processing model 522 enables to reduce computational resources required for inference; potentially at the cost of accuracy.

As a general rule, the speech features 512, 513 may include a speech spectrogram, e.g., a mel-scaled spectrogram. In the context of speech processing, a spectrogram may refer to a visual representation of the frequency content of an audio signal over time. A mel-scale spectrogram is a type of spectrogram that is specifically designed for speech processing applications. The mel scale is a perceptual scale that is based on the way humans perceive sound frequencies. In particular, the mel scale is a non-linear transformation of the frequency axis, where lower frequencies are spaced more closely together than higher frequencies. Using speech spectrograms has the benefit of being able to use a post-processing model 522 that provides an image-to-image transformation. Such post-processing models are widely available. The speech features may alternatively be defined in a machine-learned latent feature space. Thus, respective feature vectors may not necessarily be explainable in terms of acoustic features. This may have the benefit of being able to capture more nuanced characteristics of the speech.

The audio speech output 514 is adapted—through techniques that will be described later on in detail—to a particular target speaker (speaker adaptation). Thus, the audio speech output has speech characteristics resembling those of the target speaker. Speech characteristics may include various aspects of their voice, such as tone, pitch, rhythm, and cadence. Prosody refers to the rhythmic and melodic aspects of speech, including factors such as stress patterns, intonation, and pause duration.

According to various examples, the speaker adaptation of the TTS synthesis pipeline 500 is achieved by appropriately training the acoustic model 521 and the post-processing model 522. On the other hand, the vocoder 523 may not be specifically adapted to the target speaker. I.e., a speaker-independent vocoder 523 may be used. This has the benefit of not having to re-train the vocoder 523 for each particular target speaker; typically, re-training the vocoder 523 requires significant computational resources so that by rather training the upstream models 521, 522 a reduced computational complexity can be obtained.

While FIG. 1 has been explained above in the context of the TTS synthesis pipeline 500, the disclosed aspects are equally applicable to other forms of speech synthesis. In particular, the disclosed techniques are also applicable to an STS synthesis pipeline; such STS syntheses pipeline includes similar elements as depicted in FIG. 1 (e.g., the acoustic model 521, the generative post-processing model 521, and the vocoder 523) and only differs with respect to the nature of the input to the acoustic model 521. In detail, instead of accepting text inputs (e.g., a sequence of phoneme symbols), the acoustic model 521 operates based on speaker-independent speech features, e.g., phoneme posteriorgrams. For example, such phoneme posteriorgrams may be derived from the output of an automatic speech recognition system, which is trained to predict the likelihood of each phoneme being present in a given frame of speech. Thereby, they disentangle speaker-independent pronunciation features from speaker identity. Phoneme posteriorgrams may be represented as a matrix, where each row corresponds to a particular time step and each column corresponds to a specific phoneme (e.g., [aa], [ae], etc.). The values in the matrix represent the probability of each phoneme being present at each time step.

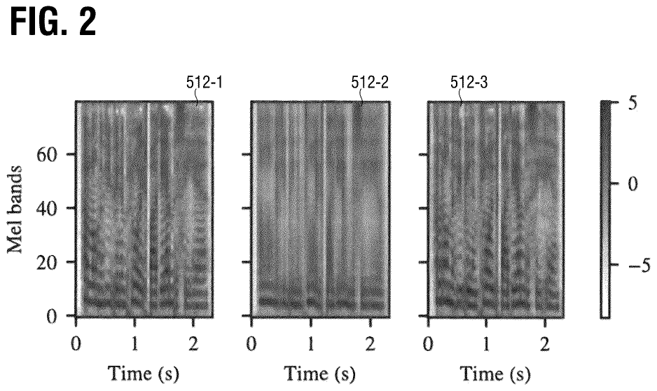

Various techniques are based on the finding that training of the acoustic model 521 based on I/O datasets having only a limited amount of training samples (low-resource I/O datasets) can lead to poor performance of the acoustic model 521 when inferring speech features 512. In particular, the quality of synthetic speech is poor. The audio output may sound artificial. This is illustrated in FIG. 2.

FIG. 2 illustrates the typical deficiencies of synthetic spectrograms and the potential of techniques for speaker adaptation disclosed herein. 512-1 is a real (i.e., measured) spectrogram and 512-2 is the associated synthetic speech spectrogram obtained from an acoustic model that has been trained using a low-resource I/O dataset. From a comparison of the spectrogram 512-1 with the spectrogram 512-2, the over-smoothing becomes apparent, i.e., the lack of fine-grained noise-like texture the spectrogram 512-2 if compared to the spectrogram 512-1. If the spectrogram 512-2 is fed to a vocoder such as the vocoder 523, the associated audio speech output sounds artificial. To improve the naturalness of the speech output, a more natural modified spectrogram 512-3 can be obtained using training techniques of the TTS synthesis pipeline 500 according to various examples that will be explained in detail below.

These training techniques employ a first I/O dataset for the target speaker. This first I/O dataset may be referred to as low-resource target speaker I/O dataset. The training techniques also employ one or more second I/O datasets for one or more reference speakers. These one or more second I/O datasets may be referred to as high-resource reference speaker I/O datasets. All I/O datasets include training samples for a single respective speaker. Different I/O datasets are, however, associated with different speakers.

For sake of simplicity, hereinafter, it is assumed that multiple high-resource reference speaker I/O datasets are available; however, the techniques disclosed herein also generally work with only a single high-resource reference speaker I/O dataset.

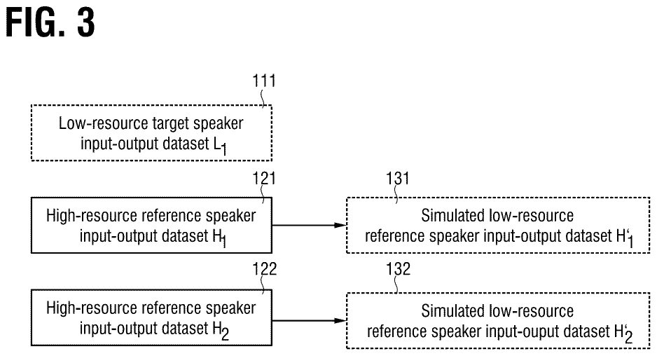

FIG. 3 illustrates the low-resource target speaker I/O dataset 111, labeled L₁. FIG. 3 also illustrates two high-resource reference speaker I/O datasets 121, 122, labeled H₁, H₂.

For instance, the multiple high-resource reference speaker I/O datasets 121, 122 may be obtained from publicly available resources.

If there are multiple candidate high-resource reference speaker I/O datasets, it is an option to select those high-resource reference speaker I/O datasets associated with speakers that are most similar to the target speaker. Such selection may be based on a speaker embedding function indicative of speaker similarity. Thus, generally, the multiple high-resource reference speaker I/O datasets 121, 122 can be selected from a plurality of respective candidates based on, e.g., prosody control data determined for the target speaker and/or a speaker characteristic of the target speaker.

Each of the multiple high-resource reference speaker I/O datasets 121, 122 is significantly larger than the low-resource target speaker I/O dataset 111. I.e., each of the multiple high-resource reference speaker I/O datasets 121, 122 includes more training samples and/or the training data included in the training samples corresponds to longer audio associated with the speech features if compared to the low-resource target speaker I/O dataset 111. This means that, e.g., a ratio M of the size of each of the multiple high-resource reference speaker I/O datasets 121, 122 to the size of the low-resource target speaker I/O dataset 111 is at least 10, i.e., M≥10. I.e., any given high-resource reference speaker I/O dataset 121, 122 includes at least 10 times more and/or longer speech features (e.g., ten times longer audio data) and/or 10 times more and/or longer text inputs if compared to the low-resource target speaker I/O dataset 111. For example, the low-resource target speaker I/O dataset 111 may include speech features corresponding to approximately 15 minutes of audio. In contrast, each of the high-resource reference speaker I/O datasets 121, 122 may include speech features corresponding to approximately 5 hours of audio.

As illustrated in FIG. 3, for each of the multiple high-resource reference speaker I/O datasets 121, 122, a respective third I/O dataset 131, 132 is determined. These third I/O datasets 131, 32 include only a part of the text inputs and associated speech features of the respective associated high-resource reference speaker I/O dataset 121, 122. For instance, the third I/O dataset 131 only includes a part of the training samples of the high-resource reference speaker I/O dataset 121. Accordingly, the third I/O datasets 131, 132 are smaller than the associated high-resource reference speaker I/O datasets 121, 122. Accordingly, the third I/O datasets 131, 132 may be referred to as simulated low-resource reference speaker I/O datasets 131, 132. The simulated low-resource reference speaker I/O datasets 131, 132 are labeled with H₁′ and H₂′, respectively, in FIG. 3.

The simulated low-resource reference speaker I/O datasets 131, 132 are artificially reduced in size to thereby help training reference instances of the acoustic model of the TTS synthesis pipeline; these reference instances of the acoustic model are used to generate further training samples for the generative post-processing model of the TTS synthesis pipeline. The generator model thus better learns to compensate for the typical deficiencies of the speech features from an acoustic model trained on low-resource data and, therefore, improve the overall TTS quality for the low-resource voice.

The simulated low-resource reference speaker I/O datasets 131, 132 may be obtained, from the respective high-resource reference speaker I/O datasets 121, 122 by sampling in accordance with a sampling scheme. The sampling scheme may include a randomized component. Thus, training samples may be randomly drawn from the respective high-resource reference speaker I/O dataset 121, 122 and included in the associated simulated low-resource reference speaker I/O dataset 131, 133, e.g., until a threshold size of the simulated low-resource reference speaker I/O dataset 131, 132 is reached.

The simulated low-resource reference speaker I/O datasets may mimic properties of the low-resource target speaker I/O dataset 111. This may be achieved, e.g., by using a sampling scheme that is based on a distribution of temporal durations of speech features of the low-resource target speaker I/O dataset 111. For instance, the sampling may be such that the distribution of temporal durations of the speech features of each of the simulated low-resource reference speaker I/O datasets 131, 132 is similar to the distribution of temporal durations of speech features of the low-resource target speaker I/O dataset 111. Alternatively or additionally to using the distribution of temporal durations of the speech features it would also be possible to use a length of the inputs. In a concrete example, the probability density function of the low-resource target speaker I/O dataset's audio recording durations is determined by applying a kernel-density estimate using Gaussian kernels. Then, this probability density function is evaluated on the durations from a given high-resource reference speaker I/O dataset and the obtained probabilities are used as weights in a weighted sampling procedure; e.g., without replacement such that a sample cannot be drawn multiple times. Sampling is stopped when the simulated low-resource reference speaker I/O dataset has an overall duration equal to or greater than the low-resource target speaker I/O dataset.

Thus, to further mimic properties of the low-resource target speaker I/O dataset 111, a ratio N of the size of each of the simulated low-resource reference speaker I/O datasets to the size of the low-resource target speaker I/O dataset 111 may be in the range of 0.5 to 1.5, i.e., 0.5≤N≤1.5 I.e., a size of each of the simulated low-resource reference speaker I/O datasets 131, 132 may be approximately equal to the size of the low-resource target speaker I/O dataset 111.

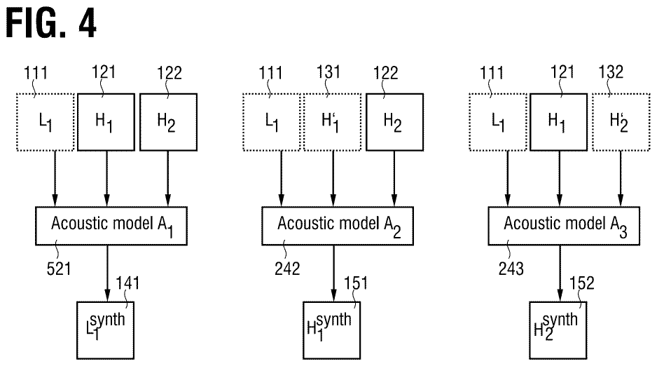

Next, training commences based on the available speaker I/O datasets 111, 121, 122, 131, 132. This is shown in FIG. 4.

As shown in FIG. 4, the acoustic model 521 and two reference instances 242, 243 of the acoustic model (labeled A₁, A₂, A₃) are trained. To train the acoustic model 521, the low-resource target speaker I/O dataset 111 as well as both high-resource reference speaker I/O datasets 121, 122 are used. The reference instances 242, 243 are not used for inference in the TTS synthesis pipeline (hence, the name “reference instance”); but are merely proxies for obtaining a better training of the post-processing model 522 of the TTS synthesis pipeline 500.

In detail, the reference instance 242 is trained based on the low-resource target speaker I/O dataset 111 and the high-resource reference speaker I/O dataset 122 as well as the simulated low-resource reference speaker I/O dataset 131. The reference instance 243 is trained based on the low-resource target speaker I/O dataset 111 and the high-resource reference speaker I/O dataset 121 as well as the simulated low-resource reference speaker I/O dataset 132. For this training, a loss can be used such as the mean absolute error between the synthesized speech features and the ground-truth speech features. The same loss function may be used for training the acoustic model 521 and the reference instances 242, 243.

Note that while FIG. 4 illustrates training of two reference instances 242, 243, the process can be extended to more than two high-resource reference speaker I/O datasets as well as associated simulated low-resource reference speaker I/O datasets and reference instances of the acoustic model.

Furthermore, in another variant, only a single reference instance is used. This scenario may be helpful if only a single high-resource reference speaker I/O dataset is available; then, this single high-resource reference speaker I/O dataset is used to generate a simulated low-resource reference speaker I/O dataset and the reference instance of the acoustic model is then trained based on the low-resource target speaker I/O dataset and that simulated low-resource reference speaker I/O dataset.

Then, the acoustic model 521 is used to infer synthesized speech features 141

$$( labeled {L}_{1}^{synth} ) ;$$

this is based on inputs included in the low-resource target speaker I/O dataset 111. Similarly, the reference instance 242 of the acoustic model 521 is used to infer synthesized reference speech features 151

$$( {H}_{1}^{synth} )$$

based on inputs included in the simulated low-resource reference speaker I/O dataset 131 and/or the high-resource reference speaker I/O dataset 121. Finally, the reference instance 243 of the acoustic model 521 is used to infer synthesized reference speech features 152

$$( {H}_{2}^{synth} )$$

based on inputs included in the simulated low-resource reference speaker I/O dataset 132 and/or the high-resource reference speaker I/O dataset 122.

Thus, in other words, the acoustic model 521 and its reference instances 242, 243 are used to generate low-quality synthesized speech features 141, 151, 152 as training data for the GAN. To this end, the particular reference instance 242, 243 is used for that associated high-resource reference speaker I/O dataset 121, 122 that has been used in its low-resource variant to train that reference instance 242, 242.

Finally, the post-processing model 522 can be trained on this compound training data, i.e., based on the synthesized speech features 141, the synthesized reference speech features 151, 152, and (as ground truth) the associated speech features included in the I/O datasets 111, 121, 122.

The post-processing model 522 is trained to minimize a difference between modified speech features inferred, by the post-processing model 522, from the synthesized speech features 141 and the associated speech features included in the low-resource target speaker I/O dataset 111. The post-processing model 522 is also trained to minimize a difference between further modified speech features inferred, by the post-processing model 522, from the synthesized reference speech features 151, 152 and associated speech features included in the respective high-resource reference speaker I/O datasets 121, 122. For an implementation of the post-processing model 522 as a GAN, such training can be based on an optimization aim of the generator model that increases the discriminator model's probability for the synthesized speech feature (where a high probability indicates ground-truth speech features). Training of a GAN thus involves jointly optimizing the parameters of both the generator model and the discriminator model. The optimization aim of the generator model is typically to increase the discriminator model's probability for the synthesized speech feature, where a high probability indicates that the generated speech feature sample is close to being indistinguishable from real speech feature samples. This can be achieved through various optimization techniques, such as stochastic gradient descent or Adam optimization.

According to various examples, the synthetic and real speech features used for training the GAN are as similar as possible (except for their naturalness). Thus, it may be beneficial to enforce the same prosody (e.g., pitch, speech rhythm and/or energy) in synthetic and real speech features by employing an architecture of the acoustic model with explicit prosody control. Here, ground-truth prosody features derived from the real examples may be used to generate the corresponding synthetic speech features. In other words, the acoustic model can be controlled to infer the synthesized speech features in accordance with prosody control data for the target speaker while each of the reference instances of the acoustic model are controlled to infer the respective synthesized reference speech features in accordance with respective prosody control data for the respective reference speakers. The prosody control data for the target speaker can be determined by analyzing the low-resource target speaker I/O dataset, e.g., using a model that is configured to extract the prosody for each included training sample.

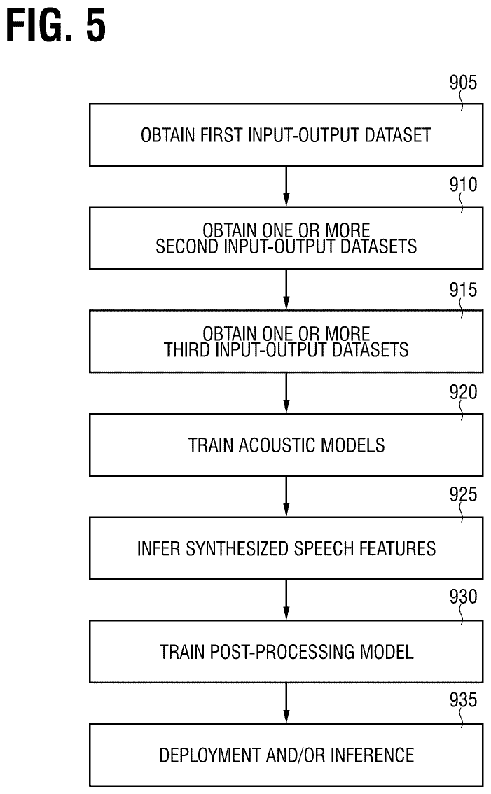

FIG. 5 is a flowchart of a method according to various examples. The method of FIG. 5 may be executed by a processing device. The method of FIG. 5 may be executed by at least one processor, upon loading program code from at least one memory and upon executing the program code. According to examples, different boxes of FIG. 5 are executed by different processing devices. For instance, a client-cloud interaction of processing logic may be possible.

FIG. 5 relates to obtaining a speech synthesis pipeline that is adapted to a specific target speaker. In particular, the speech synthesis pipeline includes an acoustic model, a generative post-processing model—e.g., a generator model of a GAN—as well as a vocoder.

The techniques disclosed herein are particularly concerned with training the acoustic model as well as the generative post-processing model based on a speaker-specific I/O dataset for the target speaker. The training process described in FIG. 5 results in an improved audio speech output from the vocoder, having improved naturalness and accurately mimicking the speech of the target speaker.

At box 905, a first I/O dataset is obtained. This is a low-resource target speaker I/O dataset that includes inputs—e.g., for TTS synthesis, text inputs; or for STS synthesis speaker-independent speech features—and associated speech features (e.g., speech spectrograms or speech features that are defined in a machine-learned latent feature space) for a target speaker.

Next, at box 910, one or more second I/O datasets are obtained. These are high-resource reference speaker I/O datasets that includes inputs—e.g., for TTS synthesis, text inputs; or for STS synthesis speaker-independent speech features—and associated speech features (e.g., speech spectrograms or speech features that are defined in a machine-learned latent feature space), each for a respective reference speaker.

All I/O datasets are single-speaker datasets. I.e., the I/O datasets of box 905 as well as of box 910 only include inputs and associated speech features for a respective single speaker. However, different ones of the I/O datasets are associated with different speakers.

Box 910 may include loading the one or more high-resource reference speaker I/O datasets from a cloud repository. In particular, the one or more high-resource reference speaker I/O datasets may be publicly available in the cloud repository. On the other hand, box 905 may include loading the target speaker I/O dataset from a user storage. The target speaker I/O dataset may be a proprietary dataset. Each of the one or more high-resource reference speaker I/O datasets of box 910 may be larger than the low-resource target speaker I/O dataset of box 905, e.g., by a factor of at least 10. For instance, a duration of audio associated with the speech features in the low-resource target speaker I/O dataset may not exceed one hour or optionally not exceed 30 minutes; while a duration of audio data associated with the speech features in the high-resource reference speaker I/O dataset may exceed one hour or preferably 5 hours.

The one or more high-resource reference speaker I/O datasets of box 910 may be selected based on a similarity of speech characteristics to the low-resource target speaker I/O dataset of box 905. For instance, the one or more high-resource reference speaker I/O datasets of box 910 may be selected from multiple candidates based on at least one of prosody control data for the target speaker and/or a speaker characteristic of the target speaker.

At box 915, a respective third I/O dataset is obtained for each of the one or more high-resource reference speaker I/O datasets of box 910. In detail, for each high-resource reference speaker I/O dataset, a corresponding low-resource reference speaker I/O dataset is obtained, by selecting only parts of the inputs—e.g., for TTS synthesis, text inputs; or for STS synthesis speaker-independent speech features—and associated speech features from the respective high-resource reference speaker I/O dataset. This can include sampling using a sampling scheme (also cf. FIG. 3). For instance, random sampling or sampling to mimic a distribution of temporal durations of speech features of the low-resource target speaker I/O dataset of box 905 can be applied. Each of the low-resource reference speaker I/O datasets has a size that is approximately equal to the size of the low-resource target speaker I/O dataset of box 905.

At box 920, the acoustic model of the synthesis pipeline (cf. acoustic model 521 of the TTS synthesis pipeline 500 in FIG. 1) is trained using the low-resource target speaker I/O dataset and at least one of the one or more high-resource reference speaker I/O datasets (cf. FIG. 4, left part). For instance, all available high-resource reference speaker I/O datasets of box 910 may be used.

Further, at box 920, for each of the low-resource reference speaker I/O datasets, a respective reference instance of the acoustic model is trained, using the respective low-resource reference speaker I/O dataset as well as (if available) a least one of the remaining high-resource reference speaker I/O datasets not associated with the respective low-resource reference speaker I/O dataset. Furthermore, the low-resource target speaker I/O dataset is used (cf. FIG. 4: middle part and right part). If only a single high-resource reference speaker I/O dataset is available and this single high-resource reference speaker I/O dataset has been used to generate the associated low-resource reference speaker I/O dataset, then the respective reference instance of the acoustic model is trained solely based on the low-resource target speaker I/O dataset and the low-resource reference speaker I/O dataset. In this case, since the reference instance of the acoustic model is trained on a comparatively small number of training samples (only low-resource I/O datasets are used for this training), care should be taken that the artifacts in the synthesized speech features (cf. box 925) obtained from this reference instance match well to the artifacts in the synthesized speech features obtained from the acoustic model itself (which has been trained based on the high-resource reference speaker I/O dataset, as well, and thus based on a comparatively larger number of training samples). If the artifacts in the synthesized speech features obtained from the acoustic model and the synthesized speech features obtained from the reference instance of the acoustic model are comparable, then the generative post-processing model can be trained efficiently to reduce artifacts based on all these synthesized speech features.

At box 925, synthesized speech features are inferred. This is based on the acoustic model as well as the one or more reference instances of the acoustic model. Prosody control data for the respective target speaker or reference speaker may be considered, so that the synthesized speech features mimic the ground-truth speech features in the I/O datasets of box 905 and box 910, respectively. In detail, the acoustic model is used to infer synthesized speech features based on inputs that are included in the low-resource target speaker I/O dataset. Respective aspects have been previously discussed in connection with FIG. 4: synthesized speech features 141. Furthermore, each reference instance of the acoustic model is used to infer respective synthesized reference speech features (cf. FIG. 4: synthesized reference speech features 151, 152) based on the inputs that are included in the associated high-resource reference speaker I/O dataset.

At box 930, based on the available synthesized speech features of box 925 as well as based on the ground-truth speech features included in the I/O datasets of box 905 and box 910, the generative post-processing model of the synthesis pipeline is trained.

At optional box 935, the trained synthesis pipeline may be deployed and/or inferred. For instance, the acoustic model and the generative post-processing model can be stored to a user storage. Alternatively or additionally, speech outputs can be inferred based on inputs. The speech outputs can be played back. The speech output mimic the speech characteristic of the target speaker and have better naturalness if compared to a reference implementation in which the reference instances of the acoustic model are not used to obtain additional training samples for the generative post-processing model.

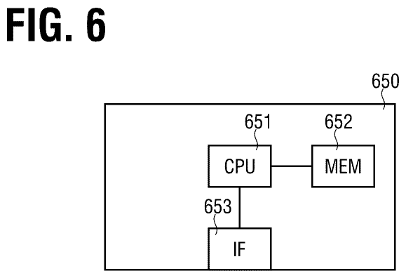

FIG. 6 schematically illustrates a processing device 650 according to various examples. The processing device 650 includes a memory 652 as well as a processor 651. The processor 651 may load program code from the memory 652 and execute the program code. Upon executing the program code, the processor 651 may perform techniques as disclosed herein, e.g., inferring synthesized speech from an input based on a speech synthesis pipeline, training at least parts of a speech synthesis pipeline, training and acoustic model of the speech synthesis pipeline, training a generative post-processing model of the speech synthesis pipeline, generating simulated low-resource reference speaker I/O datasets by selecting training samples from high-resource reference speaker I/O datasets. For example, the processor 651 may execute the method of FIG. 5.

Summarizing, techniques for speaker-adaptation of a speech synthesis pipeline with improved naturalness despite of limited availability of speaker-specific training samples have been disclosed.

The techniques have lower complexity than reference implementations in which the vocoder is re-trained on the acoustic model outputs: vocoder training usually takes a long time. Compared to techniques not employing a generative post-processing model, the disclosed speech synthesis pipeline exploits the flexible and powerful modeling capacities of generative machine-learned models that are able to generate natural noise-like textures in speech features. Compared to previous GAN-based solutions, the disclosed training strategy significantly extends the GAN's training data with low-resource characteristics, which substantially improves the GAN's capabilities to enhance the quality of the speech features for the low-resource target speaker. Since using the generative post-processing model is optional during inference, it bears the potential to flexibly choose between a lower computational cost (turning off the post-processing) and an increased synthesis quality (turning on the post-processing) at the user's preference.

Although the disclosure has been shown and described with respect to certain preferred embodiments, equivalents and modifications will occur to others skilled in the art upon the reading and understanding of the specification. The present disclosure includes all such equivalents and modifications and is limited only by the scope of the appended claims.

For illustrative purposes, while above various implementations of the generative post-processing models as a generator of a GAN have been disclosed, other types of generative post-processing models that are trained with pairs of synthetic and real data may be used, e.g., conditional flow-based models or conditional diffusion models.

For further illustration, while various aspects have been disclosed in the context of TTS synthesis, these aspects can be directly applied to other forms of speech synthesis, in particular STS.

What is claimed is:

1. A computer-implemented method of obtaining a speech synthesis pipeline adapted to a target speaker, the speech synthesis pipeline comprising an acoustic model for determining speech features based on inputs, a generative post-processing model for modifying the speech features, and a vocoder for determining an audio speech output based on the modified speech features, the method comprising:
obtaining a first input-output dataset for the target speaker, the first input-output dataset comprising respective inputs and associated speech features,
obtaining one or more second input-output datasets for one or more reference speakers, each of the one or more second input-output datasets comprising respective inputs and associated speech features, a size of each of the one or more second input-output dataset being larger than a size of the first input-output dataset,
for each of the one or more second input-output datasets: obtaining a respective third input-output dataset comprising a part of the inputs and associated speech features of the associated second input-output dataset,
training the acoustic model using the first input-output dataset and at least one of the one or more second input-output datasets,
for each of the one or more third input-output datasets: training a respective reference instance of the acoustic model using the respective third input-output dataset,
using the trained acoustic model to infer synthesized speech features based on the inputs included in the first input-output dataset,
for each trained reference instance of the acoustic model: using the respective trained reference instance of the acoustic model to infer respective synthesized reference speech features based on the inputs included in the associated second input-output dataset, and
training the generative post-processing model based on the synthesized speech features, the synthesized reference speech features, the speech features included in the first input-output dataset, and the speech features included in the one or more second input-output datasets.

2. The method of claim 1, further comprising:
for each of the one or more second input-output datasets: sampling, using a sampling scheme, from the respective inputs and associated speech features to obtain the respective third input-output dataset.

3. The method of claim 2,
wherein the sampling scheme comprises a randomized component.

4. The method of claim 2,
wherein the sampling scheme is based on a distribution of temporal durations of speech features of the first input-output dataset.

5. The method of claim 1,
wherein a ratio M of the size of each of the one or more second input-output datasets to the size of the first input-output dataset is at least 10.

6. The method of claim 1,
wherein a ratio N of the size of each of the one or more third input-output datasets to the size of the first input-output dataset is in a range of 0.5 to 1.5.

7. The method of claim 1, further comprising:
controlling the acoustic model to infer the synthesized speech features in accordance with first prosody control data for the target speaker,
controlling each of the one or more reference instances of the acoustic model to infer the respective synthesized reference speech features in accordance with second prosody control data for respective reference speakers of the one or more second input-output datasets.

8. The method of claim 7, further comprising:
determining the first prosody control data by analyzing the first input-output dataset,
wherein the method optionally further comprises:
determining the second prosody control data by analyzing the second input-output dataset.

9. The method of claim 1,
wherein the one or more second input-output datasets comprise multiple second input-output datasets,
wherein the one or more third input-output datasets comprise multiple third input-output datasets,
wherein each reference instance of the acoustic model is trained using the respective third input-output dataset and at least one of the multiple second input-output datasets not associated with the respective third input-output dataset.

10. The method of claim 1,
wherein each reference instance of the acoustic model is trained using the first input-output dataset.

11. The method of claim 1,
wherein the vocoder is not adapted to the target speaker.

12. The method of claim 1,
wherein the generative post-processing model is a generator model of a generative adversarial network.

13. The method of claim 1,
wherein the speech features comprise a speech spectrogram.

14. The method of claim 1,
wherein the speech features are defined in a machine-learned latent feature space.

15. The method of claim 1,
wherein the generative post-processing model is trained to minimize a difference between modified speech features inferred, by the generative post-processing model, from the synthesized speech features and the associate speech features included in the first input-output dataset,
wherein the generative post-processing model is trained to minimize a further difference between further modified speech features inferred, by the generative post-processing model, from the synthesized reference speech features and associated speech features included in a respective one of the one or more second input-output datasets.

16. The method of claim 1,
upon completion of said training of the generative post-processing model: using the speech synthesis pipeline to infer speech outputs for inputs, and
playing back the speech outputs.

17. The method of claim 1,
wherein obtaining the one or more second input-output datasets comprises loading the one or more second input-output datasets from a cloud repository,
wherein obtaining the first input-output dataset comprises loading the first input-output dataset from a user storage,
wherein the method further comprises:
upon completion of said training of the generative post-processing model: storing data defining the acoustic model and the generative post-processing model to the user storage.

18. The method of claim 1, further comprising:
selecting the one or more second input-output datasets from a plurality of candidate input-output datasets based on at least one of a prosody control data for the target speaker or a speaker characteristic of the target speaker.

19. A memory storing a program code that, when executed by at least one processor, causes the at least one processor to use the speech synthesis pipeline of claim 1 to infer speech outputs for inputs.

20. A processing device comprising a memory and at least one processor, the at least one processor being configured to load program code from the memory and to execute the program code, the at least one processor, upon loading and executing the program code being configured to:
obtaining a first input-output dataset for a target speaker, the first input-output dataset comprising respective inputs and associated speech features,
obtaining one or more second input-output datasets for one or more reference speakers, each of the multiple second input-output datasets comprising respective inputs and associated speech features, a size of each of the one or more second input-output datasets being larger than a size of the first input-output dataset,
for each of the one or more second input-output datasets: obtaining a respective third input-output dataset comprising a part of the inputs and associated speech features of the associated second input-output dataset,
training an acoustic model of a speech synthesis pipeline using the first input-output dataset and at least one of the one or more second input-output datasets,
for each of the one or more third input-output datasets: training a respective reference instance of the acoustic model using the respective third input-output dataset,
using the trained acoustic model to infer synthesized speech features based on the inputs included in the first input-output dataset,
for each trained reference instance of the acoustic model: using the respective trained reference instance of the acoustic model to infer respective synthesized reference speech features based on the inputs included in the associated second input-output dataset, and
training a generative post-processing model of the speech synthesis pipeline based on the synthesized speech features, the synthesized reference speech features, the speech features included in the first input-output dataset, and the speech features included in the one or more second input-output datasets.
